(19) United States
(12) Patent Application Publication
(10) Pub. No.: US 2007/0097819 A1
(43) Pub. Date: May 3, 2007

(54) Laser positioning in an optical disc drive

(76) Inventors: D. Mitchel Hanks, Fort Collins, CO (US); Lawrence Nathaniel Taugher, Fort Collins, CO (US); Paul W. Martin, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,445

(22) Filed: Oct. 31, 2005

(51) Int. Cl. G11B 7/12

(52) U.S. Cl. 369/47.49

(57) ABSTRACT

Various apparatuses and methods for laser positioning in an optical disc drive are provided. In one embodiment, a laser positioning apparatus is provided in which a first positioning assembly positions a first laser beam generated by a first laser and directed toward a first side of an optical disc site in the optical disc drive. A second positioning assembly positions a second laser beam generated by a second laser and directed toward a second side of the optical disc site in the optical disc drive. The second positioning assembly positions the second laser beam independent of the positioning of first laser beam by the first positioning assembly, the second positioning assembly further comprising an actuator that positions the second laser beam, and an elastic member that opposes a movement of the actuator.

### BACKGROUND

Recent advancements have made it possible to employ lasers in optical disc drives to perform the functions of reading data from and writing data to optical discs as well as writing labels or other information on a label surface of optical discs. In one typical scenario, to write data to a disc, the disc is placed in the disc drive and the write function is performed. Thereafter, the disc is removed from the drive, flipped over, and placed back into the drive to write a label to the label surface of the disc. However, in this scenario, the data and labeling operations are performed sequentially, with one beginning after the other one ends. The disc is not completed until both operations are finished.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a drawing of a first view of relevant components in an optical disc drive employed to direct lasers at both sides of an optical disc according to an embodiment of the present invention;

FIG. 2 is a drawing of a view of one example of a laser positioning system employed in the optical disc drive of FIG. 1 according to an embodiment of the present invention;

FIG. 3 is a drawing of a view of another example of a laser positioning system employed in the optical disc drive of FIG. 1 according to an embodiment of the present invention;

FIG. 4 is a schematic block diagram of a disc drive controller employed in the optical disc drive of FIG. 1 according to another embodiment of the present invention; and

FIG. 5 is a flow chart that shows one example of a laser positioning calibration routine executed as a portion of the disc drive controller of FIG. 4 according to an embodiment of the present invention.

### DETAILED DESCRIPTION

The optical disc drives described herein include various components as depicted in the various figures that illustrate the various concepts according to various embodiments of the present invention. However, it is also understood that the optical disc drives may include other components not shown that are not particularly pertinent to the concepts described herein.

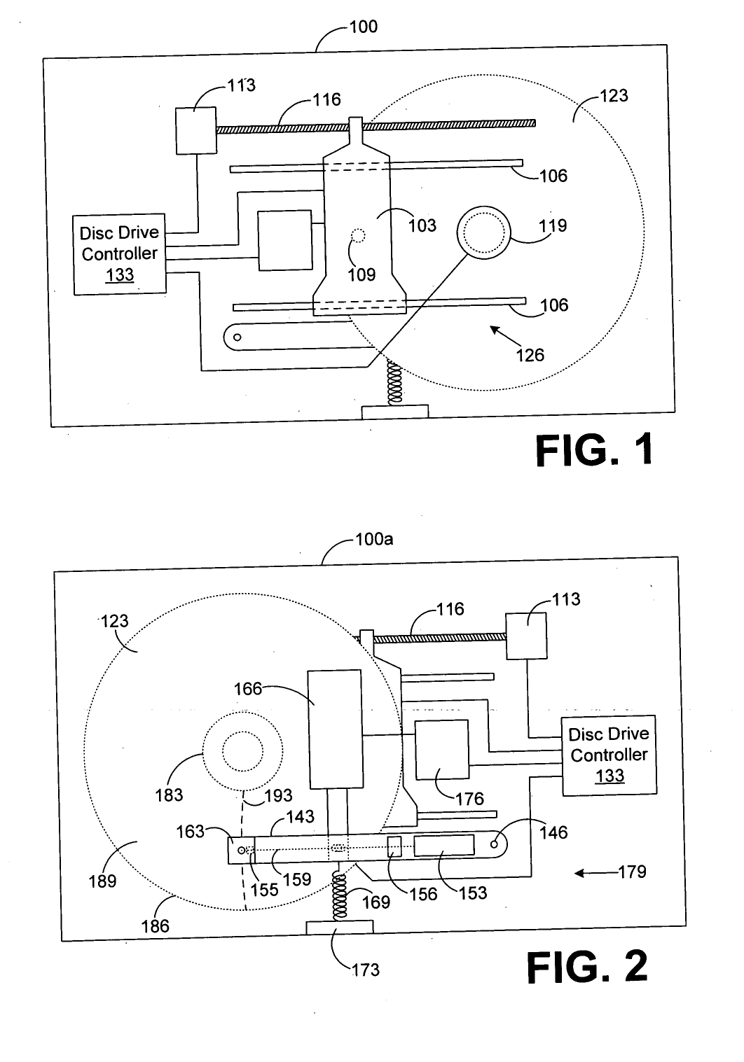

With reference to FIG. 1 shown is an optical disc drive 100 according to an embodiment of the present invention. The optical disc drive 100 includes an optical pick up unit 103 that slides along rails 106. Within the optical pick up unit 103 is a laser 109 which generates a laser beam. The optical disc drive 100 also includes a motor 113. The motor 113 may be, for example, a stepper motor or other type of motor as can be appreciated. The motor 113 is coupled to a screw shaft 116 that in turn is coupled to the optical pick up unit 103. The optical disc drive 100 further includes a spindle motor 119 that is employed to spin an optical disc placed in an optical disc site 123 of the optical disc drive 100. In this respect the optical disc site 123 comprises a three dimensional disc-like volume within which an optical disc may be placed. In this respect, the dimensions of the optical disc site 123 may approximate the dimensions of an optical disc. Also, in various embodiments, the dimensions of an optical disc may fit within the dimensions of the optical disc site 123. The optical pickup unit 103 may also be termed a “laser head” as it includes the laser 109.

The optical pick up unit 103, rails 106, the motor 113, and screw shaft 116 make up one example of a positioning assembly 126 that is employed to position the laser 109 so that a laser beam generated by the laser 109 may be directed toward a specific location on a first side of the optical disc site 123. Alternatively, assemblies other than a screw shaft/rail assembly may be employed to position the laser 109 as can be appreciated. The positioning assembly 126 is advantageously configured to position the laser beam generated by the laser 109 with a degree of accuracy and stability to facilitate reading data from and writing data to an optical disc disposed in the optical disc site 123.

The optical disc drive 100 also includes a disc drive controller 133 that generates appropriate electronic signals to drive the motor 113, the spindle motor 119, and the various components in the optical pick up unit 103. Such components may comprise, for example, the laser 109, and one or more sensors (not shown) as can be appreciated. In this respect, the disc drive controller 133 orchestrates the operation of the optical disc drive 100 in both reading data from and writing data to one side of an optical disc disposed in the optical disc site 123, and in writing a label to a label side of an optical disc placed within the optical disc site 123.

Next, with reference to FIG. 2, shown is a second view of various components of one embodiment of the optical disc drive 100, denoted herein as optical disc drive 100a according to various embodiments of the present invention. The view shown with reference to FIG. 2 is taken from an opposite direction from the view depicted in FIG. 1 of the optical disc drive 100. The optical disc drive 100a includes an arm 143 that pivots about a pivot point 146. Disposed on the arm 143 is a laser 153, a sensor 155, and beam shaping optics 156. The laser 153 generates a laser beam 159 that is shaped by beam shaping optics 156. The beam shaping optics 156 may comprise, for example, one or more lenses and other optical components as can be appreciated. Disposed at one end of the arm 143 is a reflector 163 that reflects the laser beam 159 generated by the laser 153 onto an optical disc placed in the optical disc site 123 as can be appreciated. The laser 153 may be mounted to the arm 143 in some other manner to direct the laser beam 159 toward an optical disc disposed in the optical disc site 123. For example, the laser 153 may be attached to the end of the arm 143 and pointed directly at the optical disc provided that the arm 143 is designed to provide adequate stability.

An actuator 166 is coupled to the arm 143. In one embodiment, the actuator 166 is coupled to the arm 143 at a midpoint between the ends of the arm 143, however it is understood that the actuator 166 may be coupled at any point along the arm 143 that results in the desired motion as will be described. The actuator 166 may comprise, for example, a solenoid, a voice coil motor, or other type of actuator as can be appreciated.

The optical disc drive 100a also includes an elastic member 169 that is also coupled to the arm 143. The elastic member 169 is also coupled to a frame structure 173 or other rigid structure of the optical disc drive 100a. The elastic member 169 opposes the movement of the actuator 166. In this respect, in one embodiment, the elastic member 169 exerts a force in a direction that is; aligned with a longitudinal axis that defines the direction of motion of the actuator 166. Alternatively, the elastic member 169 may be oriented such that a component of the force generated opposes the actuator 166 along the longitudinal axis of the actuator 166. The elastic member 169 may comprise, for example, a spring, an elastic material such as rubber, or other type of elastic structure as can be appreciated.

Thus, in one embodiment, where a solenoid is employed as the actuator 166, a steel core of the solenoid is coupled to the arm 143. The elastic member 169 may be a spring as described above. The solenoid includes a coil that causes a magnetic force to be exerted onto the steel core by generating a magnetic field as can be appreciated. When a current is generated in the coil, the resulting magnetic field pulls the steel core toward the center of the solenoid. The pulling force is opposed by the spring or other elastic member 169. For a given solenoid current, the arm 143 settles at an equilibrium point where the force in the spring or other elastic member 169 equals the force on the solenoid core generated by the magnetic force from the solenoid. As the current in the solenoid coil is increased, the equilibrium point moves toward the solenoid itself.

The use of a solenoid, voice coil motor or other similar device as the actuator 166 provides a distinct advantage in that the movement of the laser 153 is accomplished at reduced cost. Specifically, solenoids and voice coil motors, for example, are relatively low cost items as compared with other devices that provide higher precision of movement.

The disc drive controller 133 includes an output interface with a digital-to-analog converter that is coupled to an input of an analog amplifier 176. The output of the analog amplifier 176 is coupled to the input of the actuator 166.

Together the arm 143, actuator 166, and the elastic member 169 comprise a positioning assembly 179 that is employed to position the laser beam 159 generated by the laser 153 and directed toward the side of the optical disc site 123 by the reflector 163 along a path 193 as will be discussed subsequently in greater detail. The positioning assembly 179 can position the laser beam 159 independent of the positioning of the laser beam generated by the laser 109 by the positioning assembly 126. The disc drive controller 133 is operatively coupled to the positioning assembly 179 and the positioning assembly 126 to direct the positioning of each.

According to one embodiment, the laser 109 is a “data side” laser, and the laser 153 is a “label side” laser. A data side laser is defined herein as a laser that is employed to read or write data to a data region or data surface of an optical disc disposed in the optical disc site 123. A label side laser is defined herein as a laser employed to write a label to a label region or a label surface of an optical disc disposed in the optical disc site 123.

Next, the operation of the optical disc drive 100a is described with reference to both FIGS. 1 and 2 according to the various embodiments of the present invention. To begin, the disc drive controller 133 controls the laser positioning assembly 126 to position a first laser beam (not shown) generated by the laser 109 and directed toward a first side of the optical disc site 123 in the optical disc drive 100a. The position of the first laser beam is controlled as such so as to facilitate writing data to or reading data from an optical disc. In this respect, given that the optical pick up unit 123 or laser head is disposed on rails 106 as shown, the laser positioning assembly 126 is thus configured for linear positioning of the first laser beam generated by the laser 109 relative to the optical disc site 123 or relative to an optical disc disposed in the optical disc site 123. In this respect, a user may place an optical disc in the optical disc drive 100a such that the optical disc occupies the optical disc site 123. Thus, in one embodiment, the positioning assembly 126 employs a screw drive system that moves the optical pick-up unit 103 or laser head based upon rotation of the screw 116 by the motor 113. However, it is understood that other types of assemblies may be employed.

The positioning assembly 179 positions the second laser beam 159 at a point between an inner diameter 183 and an outer diameter 186 of the optical disc site 123. In this respect, the optical disc site 123 defines a write area 189 between the inner diameter 183 and the outer diameter 186 to which either a label or data may be written to, or data read from an optical disc that occupies the optical disc site 123. The positioning assembly 179 positions the second laser beam 159 by virtue of a displacement of the actuator 166. Specifically, in the embodiment shown in FIG. 2, the actuator 166 is coupled to the arm 143 and causes the arm 143 to pivot about the pivot point 146. The elastic member 169 is extended when the actuator 116 causes the arm 143 to pivot toward the inner diameter 183 of the optical disc site 123. Similarly, the elastic member 169 recovers its non-extended shape when the actuator 166 moves the arm 143 toward the outer diameter 186 of the optical disc site 123. In this respect, the elastic member 169 generates a force that opposes the movement of the actuator 166 when the actuator 166 pulls the arm 143 toward the inner diameter 183.

The pivotal movement of the arm 143 positions the second laser beam 159 along a path 193 that traces an arc (an arcuate path), for example, on the optical disc site 123. Thus, the displacement of the actuator 166 causes the pivotal movement of the arm 143 about the pivot point 146, thereby positioning the second laser beam 159 along the path 193. Because the arm 143 positions the laser beam 159 along the path 193 tracing the arc from the inner diameter 183 to the outer diameter 186, the label writing function of the optical disc 100a is adjusted to account for displacement of the laser beam 159 along the arc (path 193) rather than a straight line path as for the laser 109 that is moved along the rails 106.

The movement of the actuator 166 is caused by the application of a signal, such as a current, generated by the amplifier 176 based upon a signal from the disc drive controller 133. Specifically, to move the laser beam 159 to a predefined location along the path 193, the disc drive controller 133 generates a digital value that falls within a range that corresponds to the inner diameter 183 and the outer diameter 186. This value is converted by the interface described above into an analog value that is applied to the amplifier 176. In response, the amplifier generates a current that is in turn applied to the actuator 166, thereby causing the actuator 166 to be displaced in proportion to the magnitude of the current. The elastic member 169 opposes the movement of the actuator 166 in positioning the arm 143 toward the inner diameter 183.

Therefore, the displacement of the actuator 166, and thus the position of the second laser beam 159, is controlled by the magnitude of the current applied to the actuator 166. In this manner, the position of the laser beam 159 may be controlled to facilitate writing a label to the second side of an optical disc disposed in the optical disc site 123. Because the positioning assembly 179 is entirely independent of the positioning assembly 126, the positioning of the laser beam 159 is accomplished independent of the positioning of the laser beam generated by the laser 109 (FIG. 1).

In addition, while the actuator 166 is shown as providing a linear motion that is coupled to the arm 143, alternatively, the actuator 166 may be attached to the pivot point 146 and may generate a rotational force that is applied to the arm 143. Such a rotational force would result in the pivotal motion of the arm 143. Alternatively, other types of actuators 166 may be employed.

The spring 169 may also be of a type that is placed around the pivot point 146 and opposes the pivotal motion of the arm 143 in the direction of the inner diameter 183. Alternatively, the spring 169 may be embodied in some other configuration that generates a force that opposes the force generated by the actuator 166.

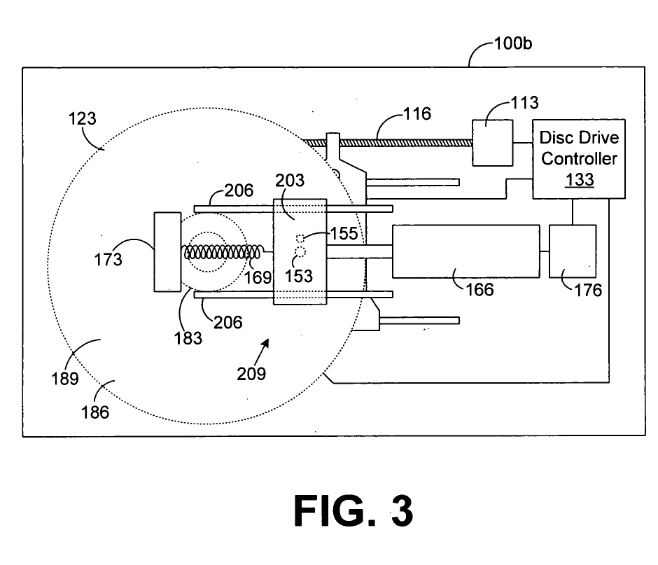

Referring next to FIG. 3, shown is a view of another example of components of the optical disc drive 100, denoted herein as optical disc drive 100b, according to an embodiment of the present invention. The view of the optical disc drive 100b of FIG. 3 is opposite that of FIG. 1. The optical disc drive 100b includes the disc drive controller 133, the amplifier 176, and the actuator 166. The actuator 166 is coupled to a laser head 203. The optical disc drive 100b also includes the elastic member 169 that is coupled between the laser head 203 and the support structure 173. The laser 153 and the sensor 155 reside in the laser head 203.

The optical disc drive 100b also includes rails 206. The laser head 203 is configured to slide along the rails 206. To this extent, the rails 206 and appropriate portions of the laser head 203 comprise guiding structure that facilitates the linear movement of the laser head 203. Such guiding structure may include slots or tunnels or other similar features that are compatible with the rails 206 that facilitate the movement of the laser head 203 along the rails 206. Both the elastic member 169 and the actuator 166 are coupled to the laser head 203 and cause the laser head 203 to move in a linear manner such that the laser 153 may be positioned anywhere from the inner diameter 183 to the outer diameter 186 of the optical disc site 133. The laser head 203, rails 206, elastic member 169, and the actuator 166 make up positioning assembly 209 that is employed to position the laser 153, and the laser beam generated thereby, along linear pathway. The disc drive controller 133 is operatively coupled to the positioning assembly 209 in order to direct the positioning of the second laser beam generated by the laser 153 in the laser head 203.

While two rails 206 are shown, it is understood that more or fewer than two rails may be employed. Also, where like numerals are employed to identify various structures in the optical disc drive 100b depicted in FIG. 3 relative to the same components in the optical disc drive 100a depicted in FIG. 2, such components are substantially similar and any detailed discussion of such components with reference to FIG. 2 applies to such components depicted in FIG. 3. A notable difference between the embodiments of FIGS. 2 and 3 is that the positioning assembly 179 of FIG. 2 facilitates the movement of the laser beam 159 along an arc 193, whereas the positioning assembly 209 of FIG. 3 facilitates the positioning of a laser beam in a linear direction.

With reference to FIGS. 1-3, the positioning assemblies 179 and 209 shown provide an advantage in that they are relatively inexpensive to implement. Also, since the positioning assemblies 179 and 209 both operate independently of the positioning of the laser 109 by the positioning assembly 126, the positioning assembly 126 is not further loaded with the burden of also positioning the laser beam 159.

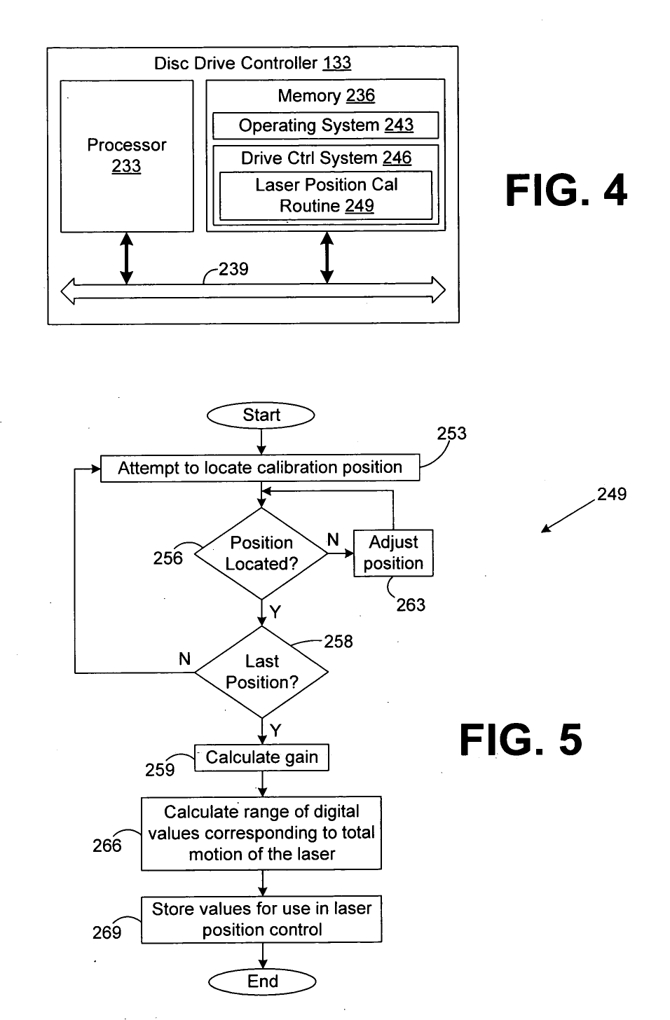

Referring then to FIG. 4, shown is one embodiment of the disc drive controller 133 according to an embodiment of the present invention. In this respect, the disc drive controller 133 comprises the processor circuit having a processor 233 and memory 236, both of which are coupled to a local interface 239. The local interface 239 may comprise, for example, a data bus with an accompanying control/address bus as can be appreciated. The processor circuit may comprise, for example, any one of a number of different commercially available microcontroller circuits as can be appreciated.

Stored in the memory 236 and executable by the processor 233 are a number of components including, for example, an operating system 243, and a drive control system 246. The operating system 243 controls the allocation and usage of hardware resources such as the memory, processing time, and peripheral devices in the disc drive controller 133. In this manner, the operating system 243 serves as the foundation on which applications depend as is generally known by those with ordinary skill in the art.

The drive control system 246 controls the various functions of the optical disc drive 100. A portion of the drive control system 246 comprises a laser position calibration routine 249. In addition, it is understood that other portions of the drive control system 246 exist that are not described herein in detail. The laser position calibration routine 249 is executed to calibrate the positioning of the laser beam 159 (FIG. 2).

The components stored in the memory 236 may be executable by the processor 233. In this respect, the term “executable” means a program file that is in a form that can ultimately be run by the processor 233. Examples of executable programs may be, for example, a compiled program that can be translated into machine code in a format that can be loaded into a random access portion of the memory 236 and run by the processor 233, etc. An executable program may be stored in any portion or component of the memory 236 including, for example, random access memory, read-only memory, a hard drive, compact disk (CD), floppy disk, or other memory components.

The memory 236 is defined herein as both volatile and nonvolatile memory and data storage components. Volatile components are those that do not retain data values upon loss of power. Nonvolatile components are those that retain data upon a loss of power. Thus, the memory 236 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 233 may represent multiple processors and the memory 236 may represent multiple memories that operate in parallel. In such a case, the local interface 239 may be an appropriate network that facilitates communication between any two of the multiple processors, between any processor and any one of the memories, or between any two of the memories etc. The processor 233 may be of electrical, optical, or molecular construction, or of some other construction as can be appreciated by those with ordinary skill in the art.

Referring next to FIG. 5, shown is a flow chart that provides one example of the operation of the laser position calibration routine 249 according to an embodiment of the present invention. Alternatively, the flow chart of FIG. 5 may be viewed as depicting steps of an example of a method implemented to calibrate the positioning of the laser beam 159. The functionality of the laser position calibration routine 249 as depicted by the example flow chart of FIG. 5 may be implemented, for example, in an object oriented design or in some other programming architecture. If the functionality is implemented in an object oriented design, then each block represents functionality that may be implemented in one or more methods that are encapsulated in one or more objects. The laser position calibration routine 249 may be implemented using any one of a number of programming languages such as, for example, C, C++, Assembly, or other programming languages along with the programming of the entire drive control system 243.

The laser position calibration routine 249 begins with box 253 in which an attempt is made to locate a calibration position along the movement of the second laser beam 159. In some embodiments, this calibration position may be considered a second calibration position where the first calibration postion is the rest position when a zero current is applied to the actuator 166. The laser position calibration routine 249 advantageously calibrates the positioning of the laser beam 159 based upon inputs received at two or more separate positions within the range of motion of the laser beam 159.

One or more of the calibration positions may be specified based on the location of reflective materials strategically placed either on an optical disc disposed in the optical disc site 123, or upon a given structure to which the laser 159 is directed when an optical disc is not disposed in the optical disc site. The reflective materials may include reflective structures such as mirrors that are configured to reflect of at least a portion of the laser beam 159. For example, one calibration point may be a point of transition between high reflectivity and low reflectivity of the edge of the outer ring media inner diameter (ID) on an optical disc placed in the optical disc site 123. Another calibration point may be, for example, the transition point from low reflectivity to high reflectivity corresponding to the edge of the write area 189.

The sensor 155 may be located on the arm 143 (FIG. 2), the laser head 203 (FIG. 2), or other location to receive the reflected laser light. When the reflected laser light is at a maximum, for example, it may be assumed that the laser beam 159 is directed at the corresponding reflective material and thus at the desired calibration position.

In box 256, assuming that the laser beam 159 is directed at the desired calibration position, then the laser position calibration routine 249 proceeds to box 258. Otherwise, the laser position calibration routine 249 proceeds to box 263. In box 263 the position of the laser beam 159 is adjusted to determine if the calibration position can be located. Thereafter, the laser position calibration routine 249 reverts back to box 256.

In box 258, the laser position calibration routine 249 determines whether the last calibration position has been located such that information relative to at least two such calibration positions is known. For example, if the rest position is taken as one of the two calibration positions, then only one other calibration positions need be located. On the other hand, if the rest position is not employed as one of the calibration positions, then at least two calibration positions within the range of motion of the laser beam 159 are located. When each of the calibration positions is located, the current or voltage applied to the actuator 166 is stored in order to calculate the gain therefrom. If in box 258, the desired number of calibration positions has been located from which the gain of the system may be calculated, then the laser position calibration routine 249 proceeds to box 259. Otherwise, the laser position calibration routine 249 reverts back to box 253 to locate the next calibration position.

When the laser position calibration routine 249 has progressed to box 259, then the gain of the actuator 166 is calculated. In this respect, the gain is calculated based upon the difference in the current or voltage applied to the actuator 166 in moving the arm 143 or laser head 203 from the rest position (or other initial calibration position) to a second calibration position. Since the distance between the two calibration positions is known, the gain may be calculated as a function of the voltage or current per unit length. In one embodiment, the analog voltage or current applied to the actuator 166 is generated by D/A converter that converts a digital position signal (digital value) into a corresponding analog voltage or current. Thus, analog voltage or current applied to the actuator 166 falls within a range that corresponds to the range of motion of the actuator 166. Since the gain varies over time, in box 266, the laser position calibration routine 249 calculates the range of digital values that corresponds to the total range of analog voltage or current that is applied to the actuator 166 to accomplish the full range of motion of the laser beam 159 given the calculated gain. Then, in box 269, these values are stored in the disc drive controller 133 for use in the laser position control. Then, the laser position calibration routine 249 ends as shown. In this manner, the laser position calibration routine 249 accounts for changes in the operation and gain of the respective positioning assemblies 179 or 209.

In order to ensure that the positioning of the arm 143 or laser head 203 is accurate over time, the laser position calibration routine 249 may be executed periodically at specific time intervals. Alternatively, the laser position calibration routine 249 may be performed before the writing of a label to each optical disc disposed in the optical disc site 123. As an alternative, the laser position calibration routine 249 may be executed according to some other schedule or scheme.

Although the laser position calibration routine 249 is described as being embodied in software or code executed by general purpose hardware as discussed above, as an alternative the same may also be embodied in dedicated hardware or a combination of software/general purpose hardware and dedicated hardware. If embodied in dedicated hardware, the laser position calibration routine 249 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIG. 5 shows the architecture, functionality, and operation of an implementation of the laser position calibration routine 249. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the laser position calibration routine 249 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the laser position calibration routine 249 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

In addition, with reference to FIGS. 1-3, various methods of use are provided relative to the optical disc drive 100. Specifically, according to one embodiment of the present invention, a method is provided for positioning a laser in an optical disc drive 100 comprising the steps of positioning a first laser beam generated by a first laser and directed toward a first side of an optical disc in an optical disc drive to read data from or write data to an optical disc. In addition, the method comprises the step of positioning a second laser beam generated by a second laser and directed toward a second side of the optical disc in the optical disc drive.

The positioning of the second laser beam is performed independent of the positioning of the first laser beam. In addition, the example method may further comprise the step of writing a label on the second side of the optical disc using the second laser beam. A user may insert the optical disc into the optical disc drive and then perform steps of positioning the first laser beam, positioning the second laser beam, and writing a label without removing the optical disc from the optical disc drive. Thereafter, the optical disc may be removed from the optical disc drive after performing all of the steps of positioning the first laser beam, positioning the second laser beam, and writing a label have been completed.

A user may advantageously employ the optical disc drive 100 to both read data from/write data to an optical disc while at the same time writing a label to an opposite side of the optical disc without having to remove the optical disc from the disc drive to flip it over to facilitate separate functions of reading/writing and writing a label using a single laser. In addition, the present invention facilitates simultaneous performance of the steps of reading data from/writing data to the optical disc and writing a label to the optical disc.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. An apparatus for laser positioning in an optical disc drive, comprising:
a first positioning assembly that positions a first laser beam generated by a first laser and directed toward a first side of an optical disc site in the optical disc drive; and
a second positioning assembly that positions a second laser beam generated by a second laser and directed toward a second side of the optical disc site in the optical disc drive, the second positioning assembly positioning the second laser beam independent of the positioning of first laser beam by the first positioning assembly the second positioning assembly further comprising an actuator that positions the second laser beam, and an elastic member that opposes a movement of the actuator.

2. The apparatus of claim 1, wherein the first positioning assembly further comprises a screw drive system that moves a laser head, wherein the first laser is located in the laser head.

3. The apparatus of claim 1, wherein the actuator further comprises a solenoid.

4. The apparatus of claim 3 wherein a displacement of the solenoid is proportional to a current applied to the solenoid.

5. The apparatus of claim 1, wherein the actuator further comprises a voice coil motor.

6. The apparatus of claim 1, wherein the elastic member further comprises a spring.

7. The apparatus of claim 1, wherein the elastic member further comprises an elastic material.

8. The apparatus of claim 1, the second positioning assembly further comprises:
a laser head, wherein the second laser is located in the laser head;
guiding structure facilitating a linear movement of the laser head; and
wherein both the elastic member and the actuator are coupled to the laser head.

9. The apparatus of claim 8, wherein the guiding structure further comprises at least one rail, wherein the laser head slides along the at least one rail.

10. The apparatus of claim 1, the second positioning assembly further comprises:
an arm that pivots about a pivot point, wherein a pivotal movement of the arm positions the second laser beam along an arcuate path;
wherein both the elastic member and the actuator are coupled to the arm, wherein the actuator positions the second laser beam by causing the pivotal movement of the arm.

11. The apparatus of claim 1, further comprising a controller operatively coupled to the second positioning assembly, the controller executing a calibration routine to calibrate a positioning of the second laser beam.

12. A method for laser positioning in an optical disc drive, comprising the steps of:
positioning a first laser beam generated by a first laser and directed toward a first side of an optical disc in the optical disc drive to read data from or write data to an optical disc; and
positioning a second laser beam generated by a second laser and directed toward a second side of the optical disc in the optical disc drive independent of the positioning of first laser beam by manipulating an actuator that positions the second laser beam, wherein an elastic member opposes a movement of the actuator.

13. The method of claim 12, further comprising the step of writing a label on the second side of the optical disc using the second laser beam.

14. The method of claim 13, further comprising the steps of
inserting an optical disc into the optical disc drive;
performing the steps of positioning the first laser beam, reading or writing the data, positioning the second laser beam, and writing the label without removing the optical disc from the optical disc drive.

15. The method of claim 12, wherein the steps of positioning the first laser beam and positioning the second laser beam are performed simultaneously.

16. The method of claim 12, wherein the step of positioning the second laser beam further comprises the step of causing a linear movement of a laser head, wherein the second laser is located in the laser head.

17. The method of claim 12, wherein the step of positioning the second laser beam further comprises the step of positioning the second laser beam along an arcuate path.

18. The method of claim 12, wherein the step of positioning the second laser beam further comprises the step of controlling a displacement of an actuator by controlling a magnitude of a current applied to the actuator, wherein the second laser beam is positioned by the displacement of the actuator.

19. The method of claim 12, further comprising the steps of:
controlling a positioning the second laser beam with a controller; and
calibrating the positioning of the second laser beam with the controller.

20. An apparatus for laser positioning in an optical disc drive, comprising:
means for positioning a first laser beam generated by a first laser and directed toward a first side of an optical disc site in the optical disc drive; and
means for positioning a second laser beam generated by a second laser and directed toward a second side of the optical disc site in the optical disc drive independent of the positioning of first laser beam by manipulating an actuator that positions the second laser beam, wherein an elastic member opposes a movement of the actuator.

21. The apparatus of claim 20, wherein the means for positioning positions the second laser beam along a linear path.

22. The apparatus of claim 20, wherein the means for positioning positions the second laser beam along an arcuate path.

23. A program embodied in a computer readable medium and executable by a computer system for calibration of a positioning assembly that positions a laser beam generated by a laser and directed toward a side of an optical disc site in an optical disc drive, the positioning assembly comprising an actuator that positions the laser beam, and an elastic member that opposes a movement of the actuator, the program comprising:
code that positions the laser beam on at least one laser calibration position; and
code that calculates a gain of the actuator from an actuator input identified from at least two laser calibration positions.

24. The program embodied in the computer readable medium and executable by the computer system of claim 23, wherein the code that positions the laser beam on at least one laser calibration position positions the laser beam on at least two laser positions.
